(19) United States
(12) Patent Application Publication
(10) Pub. No.: US 2008/0107203 A1
(43) Pub. Date: May 8, 2008

(54) SIGNALLING IN A COMMUNICATION SYSTEM

(75) Inventors: Haifeng Wang, Shanghai (CN); Wei Li, JiangSu Province (CN); Ming Chen, JiangSu Province (CN); Shixin Cheng, JiangSu Province (CN)

Correspondence Address: MORGAN & FINNEGAN, L.L.P., 3 WORLD FINANCIAL CENTER, NEW YORK, NY, 10281-2101, US

(73) Assignee: NOKIA CORPORATION, Espoo (FI)

(21) Appl. No.: 11/873,912

(22) Filed: Oct. 17, 2007

(30) Foreign Application Priority Data
Nov. 7, 2006 (GB) GB0622201.2

(51) Int. Cl. H04L 27/00

(52) U.S. Cl. 375/295; 455/101

(57) ABSTRACT

A method for providing a plurality of user equipment with a pilot sequence, the plurality of user equipment being allocated a bandwidth, the method including scattering the pilot sequence over the bandwidth orthogonally in the frequency domain among the plurality of user equipment.

### TECHNICAL FIELD

Various embodiments of the present invention relate to signalling in a communication system, and in particular, but not exclusively, to providing uplink reference signal sequences.

### BACKGROUND

Communication networks typically operate in accordance with a given standard or specification which sets out what the various elements of the network are permitted to do and how that should be achieved. For example, the standard may define the user or more precisely, user equipment is provided with a circuit switched service and/or a packet switched service. The standard may also define the communication protocols which shall be used for the connection. The given standard also defines one or more of the required connection parameters. The connection parameters may relate to various features of the connection. The parameters may define features such as the maximum number of traffic channels, quality of service and so on or features that relate to multislot transmission.

In other words, the standard defines the “rules” and parameters on which the communication within the communication system can be based. Examples of the different standards and/or specifications include, without limiting to these, specifications such as GSM (Global System for Mobile communications) or various GSM based systems (such as GPRS: General Packet Radio Service), AMPS (American Mobile Phone System), DAMPS (Digital AMPS), WCDMA (Wideband Code Division Multiple Access) or CDMA in UMTS (Code Division Multiple Access in Universal Mobile Telecommunications System) and so on.

User equipment, i.e. a terminal that is to be used for communication over a communication network, may be implemented to comply with predefined “rules” of one or more networks. User equipment may also be arranged to be compatible with more than one standard or specification, i.e. the terminal may communicate in accordance with several different types of communication services. These user equipment are often called multi-mode terminals, the basic example thereof being a dual-mode mobile station.

A communication network may be a cellular radio network consisting of cells. In most cases the cell can be defined as a certain area covered by one or several base transceiver stations (BTS) serving user equipment (UE), such as mobile stations (MS), via a radio interface and possibly connected to a base station subsystem (BSS). A feature of the cellular system is that it provides mobility for the mobile stations, i.e. the mobile stations are enabled to move from a location area to another, and even from a network to another network that is compatible with the standard the mobile station is adapted to. The user equipment (UE) within one of the cells of the cellular system can be controlled by a node providing controller function. The controller can be connected to a gateway or linking node linking the controller nodes to other parts of the communication system and/or to other communication networks.

Reference signal sequences are employed in many communication systems for channel estimation. For example, in the uplink (UL) part of a communications system, reference signal sequences are transmitted between a user equipment (UE) and a network element or node. In recent years, cyclic prefix (CP) assisted orthogonal frequency division multiplexing (OFDM) systems have been employed in many wireless communication systems. These are believed to provide high bandwidth efficiency and easy frequency domain equalization (FDE) against frequency selective fading. Furthermore, possibilities of using orthogonal frequency division multiple access, such as uplink SC-FDMA (Single Carrier—Frequency Division Multiple Access) and DFT-SOFDM (Discrete Fourier Transform—Spread Orthogonal Frequency Division Multiplexing) have been examined. These are regarded as a promising uplink access technique for B3G (Beyond Third Generation) broadband wireless networks, e.g. Evolved Universal Terrestrial Radio Access Network (E-UTRAN). Channel estimates have great impact on system performance especially in asynchronous uplink transmissions.

A technique that has been proposed to estimate the channels in some E-UTRAN proposals is Constant Amplitude Zero Auto-Correlation (CAZAC).

A Constant Amplitude Zero Auto-Correlation (CAZAC) sequence has been studied in a paper by R. L. Frank and S. A. Zadoff (“Phase shift pulse codes with good periodic correlation properties,” IRE Trans. Inform. Theory, vol. IT-8, pp. 381-382, 1962) and a paper by D. C. Chu (“Polyphase codes with good periodic correlation properties,” IEEE Trans. Inform. Theory, vol. IT-18, pp. 531-532, July 1972).

CAZAC was proposed to estimate the channel for downlink in a paper by A. Milewski (“Periodic sequences with optimal properties for channel estimation and fast start-up equalization,” IBM J Res. Develop., vol. 27, No. 5, pp. 426-431, 1983).

CAZAC has been proposed to estimate the channel for uplink in some E-UTRAN proposals due to its excellent periodic zero autocorrelation and constant amplitude property. In uplink, the received signals from simultaneously accessing users are asynchronous in general due to misalignment among the users and their propagation delays. To avoid inter-block interference, usually the misalignment among users plus the Channel Memory Length (CML) is limited within the Cyclic Prefix Length (CPL). However, such a misalignment still severely worsens the channel estimates over CAZAC sequences.

It is known that a K*CML (K denoting the number of uplink users) length CAZAC training sequence is enough to estimate the channel impulse responses of K simultaneous accessing users in synchronous communications. However, interference will be induced by the conventional time domain CAZAC multi-user channel estimations in the case of multi-access signal misalignment. The interference can be suppressed by enlarging the CAZAC sequence length from K*CML to K*CPL. However, the spectrum efficiency is correspondingly lowered by such an enlargement.

Embodiments of the present invention aim to address one or more of the above problems.

### SUMMARY

The present inventors have identified a need to provide a pilot sequence with reduced interference while retaining good spectrum efficiency. The present inventors have found that if the training sequence of a pilot signal is scattered over the bandwidth orthogonally in frequency domain among the users, rather than merely lengthening the training sequence as described above, then interference can be suppressed while good spectrum efficiency is retained.

Thus, according to an embodiment of the present invention there is provided a method for providing a plurality of user equipment with a pilot sequence, the plurality of user equipment being allocated a bandwidth, the method comprising scattering the pilot sequence over the bandwidth orthogonally in frequency domain among the plurality of user equipment.

The pilot sequence is thus scattered where all the accessing users are orthogonal in the frequency domain. The pilot sequence may be scattered over the whole bandwidth. According to one arrangement, the pilot sequence is a frequency domain orthogonally distributed CAZAC pilot sequence.

The pilot sequence may have a length of K*CML (where K is the number of uplink users and CML is the Channel Memory Length). Thus, spectral efficiency can be retained by avoiding enlargement of the training sequence to K*CPL as described in the background section.

As proved by the system analysis and simulation results discussed below, the aforementioned arrangements are more robust against misalignment among the users due to asynchronous transmission with a K*CML length CAZAC sequence when compared with a K*CML length CAZAC sequence which is not scattered over the bandwidth orthogonally in frequency domain among the plurality of user equipment. Furthermore, the arrangements have better spectrum efficiency when compared with a K*CPL length CAZAC sequence.

Embodiments of the invention can be utilized for channel estimation over a pilot channel. Embodiments may be applied to cyclic prefix-based single/multi-carrier communications. For example, embodiments of the invention can be utilized in the uplink signalling between user equipment and a communication network.

According to another embodiment of the present invention there is provided a user equipment adapted to perform the method described herein.

According to another embodiment of the present invention there is provided a network element adapted to perform the method described herein.

According to another embodiment of the present invention there is provided a telecommunications network adapted to perform the method described herein.

According to another embodiment of the present invention there is provided a computer program comprising program code means adapted to perform the method described herein when the program is run on a computer or on a processor.

According to another embodiment of the present invention there is provided a computer program product comprising program code means stored in a computer readable medium, the program code means being adapted to perform any of steps of method described herein when the program is run on a computer or on a processor.

### BRIEF DESCRIPTION OF THE FIGURES

For a better understanding of the present invention and to show how the same may be carried into effect, embodiments of the present invention will now be described by way of example only with reference to the accompanying drawings, in which:

FIG. 1 illustrates the main elements of an example network architecture;

FIG. 2 illustrates an example of transmitted pilot sequences for uplink channel estimation;

FIG. 3 illustrates multi-access signal misalignment at the receiver side;

FIG. 4 illustrates multi-access signal misalignment at the receiver side in an embodiment of the present invention;

FIG. 5 shows a symbol error rate comparison with perfect multi-user synchronization in uplink;

FIG. 6 shows a symbol error rate comparison with one-symbol multi-user signal misalignment in uplink; and

FIG. 7 shows a symbol error rate comparison with two-symbol multi-user signal misalignment in uplink.

### DETAILED DESCRIPTION

It will be understood that in the following description the present invention is described with reference to particular non-limiting examples from which the invention can be best understood. The invention, however, is not limited to such examples.

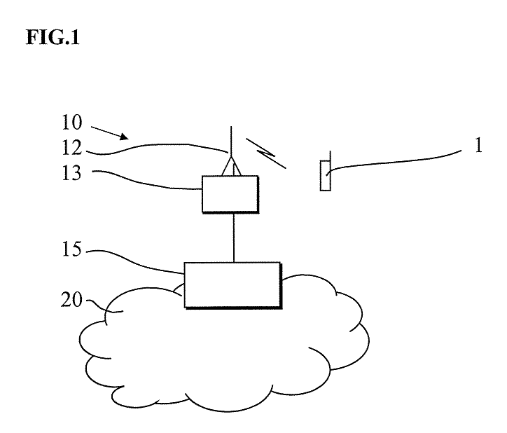

FIG. 1 shows a non-limiting example of a network architecture whereto the present principles may be applied known as the Evolved Universal Terrestrial Radio Access Network (E-UTRAN). An exemplifying implementation is therefore now described in the framework of an Evolved Universal Mobile Telecommunication System (UMTS) Terrestrial Radio Access Network (E-UTRAN). An Evolved Universal Terrestrial Radio Access Network (E-UTRAN) consists of E-UTRAN Node Bs (eNBs) which are configured to provide both base station and control functionalities of the radio access network. The eNBs may provide E-UTRA features such as user plane radio link control/medium access control/physical layer protocol (RLC/MAC/PHY) and control plane radio resource control (RRC) protocol terminations towards the mobile devices. It is noted, however, that the E-UTRAN is only given as an example and that the method can be embodied in any access system or combination of access systems.

A communication device can be used for accessing various services and/or applications provided via a communication system as shown in FIG. 1. In wireless or mobile systems the access is provided via an access interface between a mobile communication device 1 and an appropriate wireless access system 10. A mobile device 1 can typically access wirelessly a communication system via at least one base station 12 or similar wireless transmitter and/or receiver node. Non-limiting examples of appropriate access nodes are a base station of a cellular system and a base station of a wireless local area network (WLAN). Each mobile device may have one or more radio channels open at the same time and may receive signals from more than one base station.

A base station is typically controlled by at least one appropriate controller entity 13 so as to enable operation thereof and management of mobile devices in communication with the base station. The controller entity is typically provided with memory capacity and at least one data processor. In FIG. 1 the base station node 12 is connected to a data network 20 via an appropriate gateway 15. A gateway function between the access system and another network such as a packet data network may be provided by means of any appropriate gateway node, for example a packet data gateway and/or an access gateway.

CAZAC sequences and their application in a channel estimation method will now be described.

Consider a code {pₖ} of length N composed of unity modulus complex numbers, and define the cyclic autocorrelation function in (2.1)

$${c}_{l} = \{ \begin{matrix}{\sum }_{k = 0}^{N - 1} {p}_{k} {p}_{k}^{*} , & l = 0 \\ {\sum }_{k = 0}^{N - l - 1} {p}_{k} {p}_{k + l}^{*} + {\sum }_{k = N - l}^{N - 1} {p}_{k} {p}_{k + l - N}^{*} , & l \leq l \leq N - 1\end{matrix} \} \qquad ( 2.1 )$$

where * denotes conjunction and transposition. If pₖ and cₗ satisfy (2.2) and (2.3) below, {pₖ} is regarded as a Constant Amplitude and Zero Auto-Correlation (CAZAC) sequence.

$$\begin{matrix}{‖ {p}_{k} ‖}^{2} = 1 & ( 2.2 ) \\ {c}_{l} = \{ \begin{matrix}N , & l = 0 \\ 0 , & 1 \leq l \leq N - 1\end{matrix} \} & ( 2.3 )\end{matrix}$$

One example of CAZAC sequences is shown in (2.4)

$${p}_{k} = exp ( ⅈ \frac{M π {k}^{2}}{N} ) \qquad ( 2.4 )$$

where N is even and M is an integer relatively prime to N.

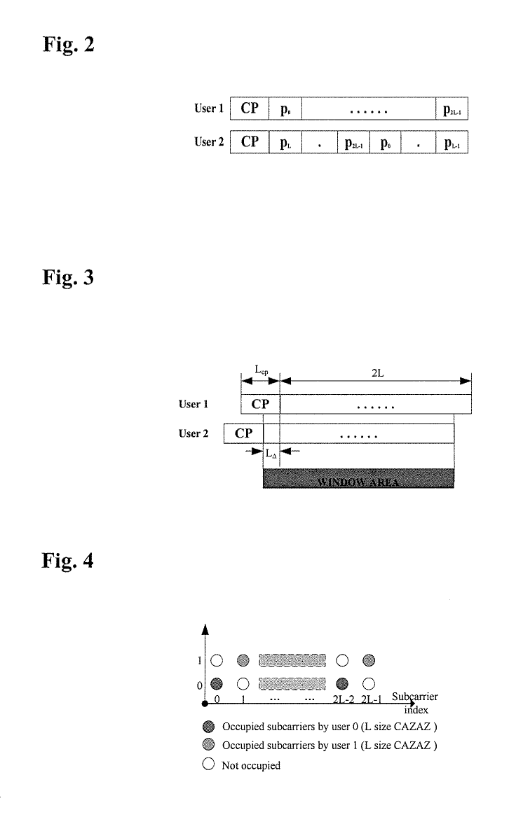

By using the cyclic-shifted CAZAC sequence, the channel information of different users can be estimated independently. In the uplink systems, a preamble with the same size as that of the data block is employed for multi-access channel estimation. It is assumed the data block size is N, the CPL is L, the number of users is K, and N=KL. For the purpose of convenience we assume that K=2 and each user occupies L sub-carriers equally distribute in the whole frequency band. The illustration of the cyclic-shifted CAZAC sequence proposal for two uplink users is shown in FIG. 2.

Besides FIG. 2, we model the received signal from two user's training sequences after CP removal in (3.1), where we assume the received signals of two users are perfectly synchronous

$$\begin{matrix}y = {h}^{1} * {s}^{1} + {h}^{2} * {s}^{2} + n \\ = {\sum }_{l = 0}^{L - 1} ( {h}_{l}^{1} {s}^{1} ( l ) + {h}_{l}^{2} {s}^{2} ( l ) ) + n\end{matrix} \qquad ( 3.1 )$$

where y, n, s¹, and s² denote the 2L×1 size received signal, independent identical distribution (i.i.d) Gaussian noise, and training sequences of two users in FIG. 2, respectively. h¹ and h² denote the L×1 size channel information related to user 1 and 2, respectively. * denotes the cyclic convoluting operation and the function s¹(l),s²(l) denote the cyclic-shift l times on sequences s¹ and s² respectively. It is noted that s²=s¹(L). Therefore the channel information can be estimated by (3.2):

$$\hat{h} = \frac{1}{2 L} [ \begin{matrix}{y}^{*} {s}^{1} ( 0 ) \\ ⋮ \\ {y}^{*} {s}^{1} ( L - 1 ) \\ {y}^{*} {s}^{1} ( L ) \\ ⋮ \\ {y}^{*} {s}^{1} ( 2 L - 1 )\end{matrix} ] = [ \begin{matrix}{h}^{1} \\ {h}^{2}\end{matrix} ] + \tilde{n} \\ \tilde{n} = \frac{1}{2 L} [ \begin{matrix}{n}^{*} {s}^{1} ( 0 ) \\ ⋮ \\ {n}^{*} {s}^{1} ( L - 1 ) \\ {n}^{*} {s}^{1} ( L ) \\ ⋮ \\ {n}^{*} {s}^{1} ( 2 L - 1 )\end{matrix} ] \qquad ( 3.2 )$$

where ñ is also an i.i.d Gaussian noise.

To avoid inter-block interference, the multi-access signal is asynchronous (misaligned) among the users and the maximum delay spread is limited with the guard interval (also named as cyclic prefix) length. The misalignment among users still induces a severe problem on channel estimation over the conventional uplink CAZAC sequence. The misalignment among the users is illustrated in FIG. 3 where L_{cp}, L_{Δ} are the length of the CP length and the receiving signal misalign length, respectively. The CML is L and the CAZAC training sequence length is 2L, as in the previous section.

According to our assumptions above, L_{cp}>L, L_{cp}−L>L_{Δ}, and the channel information of two users can be estimated based on the received signals in the window area, which is modelled in (3.3).

$$\begin{matrix}y = {h}^{1} * {s}^{1} ( {L}_{Δ} ) + {h}^{2} * {s}^{2} + n \\ = {\sum }_{l = 0}^{L - 1} ( {h}_{l}^{1} {s}^{1} ( l + {L}_{Δ} ) + {h}_{l}^{2} {s}^{2} ( l ) ) + n\end{matrix} \qquad ( 3.3 )$$

If we still use the channel estimation algorithm in (3.2), the result is shown in (3.4).

$$\begin{matrix}\hat{h} = [ \begin{matrix}{y}^{*} {s}^{1} ( 0 ) \\ ⋮ \\ {y}^{*} {s}^{1} ( L - 1 ) \\ {y}^{*} {s}^{1} ( L ) \\ ⋮ \\ {y}^{*} {s}^{1} ( 2 L - 1 )\end{matrix} ] \\ = [ \begin{matrix}{0}_{{L}_{Δ} \times 1} \\ {h}^{1} [ 0 : L - {L}_{Δ} - 1 ] \\ {h}^{1} [ L - {L}_{Δ} : L - 1 ] \\ {0}_{( L - {L}_{Δ} ) \times 1}\end{matrix} ] + [ \begin{matrix}{0}_{{L}_{Δ} \times 1} \\ {0}_{( L - {L}_{Δ} ) \times 1} \\ {h}^{2} [ 0 : {L}_{Δ} - 1 ] \\ {h}^{2} [ {L}_{Δ} : L - 1 ]\end{matrix} ] + \tilde{n}\end{matrix} \qquad ( 3.4 )$$

It is noted that there exists an overlapped area in (3.4) due to the multi-access signal misalign L_{Δ}. This implies interference on channel estimates over neighbouring CAZAC sequences assigned to different users. Therefore, the conventional CAZAC sequence channel tracking scheme may not always work well in the uplink SC-FDMA/DFT-SOFDM system.

In accordance with an embodiment, an improved CAZAC channel tracking for uplink channel estimation in UPLINK SC-FDMA/DFT-SOFDM is provided. In order to avoid interference on the multi-user channel estimation in (3.4) due to multi-access signal misalign L_{Δ}, a scatter distributed frequency domain CAZAC sequence is described below.

If the amount of uplink users is K and CML is L, training sequences for KL data block size in accordance with one embodiment are given in (4.1):
sᵢ=F*_{LK}(peᵢ^{K}),i=0, . . . , K−1 (4.1)
where p is a L×1 size CAZAC sequence, [symbol] denotes Kronecker product, eᵢ^{K} is a column selective vector defined in (4.2) below and F_{LK} is an LK size FFT (Fast Fourier Transform) transforming matrix.
eᵢ^{K}=[0_{1×i} 1 0_{1×(K-i-1)}]* (4.2)

An illustration of the embodiment is shown in FIG. 4 utilizing the same assumptions as in previous sections.

Based on Lemma 1 and 2 given below, sᵢ is also a constant amplitude sequence in time domain and the pilot signals of different users are scattered in the frequency domain. Accordingly, the channel information can be estimated through the conventional frequency channel estimation proposal in OFDM system and the small time misalign L_{Δ} between different users can be compensated by user's channel estimation and frequency domain equalization (FDE) accounting for their frequency domain orthogonal pilot structure in FIG. 4.

The received signal model without multi-access signal misalignment in time domain after CP removal is given in (4.3).
y=h¹*F*_{2L}(pe₀²)+h²*F*_{2L}(pe₁²)+n (4.3)

After transforming the time domain signal to frequency domain by doing left product on both sides of (4.3) with F_{2L}, we get
F_{2L}y=diag(pe₀²)F_{2L×L}h¹+diag(pe₁²)F_{2L×L}h²+F_{2L}n (4.4)

Hence the multi-user channel estimation can be performed:

$$\begin{matrix}\begin{matrix}\tilde{h} = [ \begin{matrix}{F}_{2 L , Φ ( 0 )}^{*} {diag ( p ⊗ {e}_{0}^{2} )}^{*} y \\ {F}_{2 L , Φ ( 1 )}^{*} {diag ( p ⊗ {e}_{1}^{2} )}^{*} y\end{matrix} ] \\ = [ \begin{matrix}{h}^{1} \\ {h}^{2}\end{matrix} ] + \tilde{n}\end{matrix} \\ \tilde{n} = [ \begin{matrix} { \tilde{n}}_{1} \\ { \tilde{n}}_{2}\end{matrix} ] = [ \begin{matrix} {F}_{ 2 L , Φ ( 0 )}^{*} {( diag ( p ⊗ {e}_{ 0}^{ 2} ) )}^{*} {F}_{ 2 L} n \\ {F}_{ 2 L , Φ ( 1 )}^{*} {( diag ( p ⊗ {e}_{ 1}^{ 2} ) )}^{*} {F}_{ 2 L} n\end{matrix} ] & ( 4.5 ) \\ \begin{matrix}\tilde{h} = [ \begin{matrix}{F}_{2 L , Φ ( 0 )}^{*} {diag ( p ⊗ {e}_{0}^{2} )}^{*} y \\ {F}_{2 L , Φ ( 1 )}^{*} {diag ( p ⊗ {e}_{1}^{2} )}^{*} y\end{matrix} ] \\ = [ \begin{matrix}{h}^{1} \\ {h}^{2}\end{matrix} ] + \tilde{n}\end{matrix} \\ \tilde{n} = [ \begin{matrix} { \tilde{n}}_{1} \\ { \tilde{n}}_{2}\end{matrix} ] = [ \begin{matrix} {F}_{ 2 L , Φ ( 0 )}^{*} diag {( p ⊗ {e}_{ 0}^{ 2} )}^{*} {F}_{ 2 L} n \\ {F}_{ 2 L , Φ ( 1 )}^{*} diag {( p ⊗ {e}_{ 1}^{ 2} ) }^{*} {F}_{ 2 L} n\end{matrix} ] & ( 4.5 )\end{matrix}$$

where Φ(k) denotes the group of sub-carrier indexes for user k's pilots and F*_{2L,Φ(k)} consists of the matrix whose columns are selected from matrix F*_{2L} according Φ(k).

If there exists multi-access time misalign L_{Δ}, as shown in FIG. 2 and L_{Δ} smaller than CPL-CML, (4.3) can be rewritten into

$$y = R ( {h}^{1} * {F}_{2 L}^{*} ( p ⊗ {e}_{0}^{2} ) ) + {h}_{2} * {F}_{2 L}^{*} ( p ⊗ {e}_{1}^{2} ) + n \\ R = [ \begin{matrix}{0}_{{L}_{Δ} \times 2 L - {L}_{Δ}} & {E}_{{L}_{Δ} \times {L}_{Δ}} \\ {E}_{2 L - {L}_{Δ} \times 2 L - {L}_{Δ}} & {0}_{2 L - {L}_{Δ} \times {L}_{Δ}}\end{matrix} ] \qquad ( 4.6 )$$

where E denotes identity matrix. After time to frequency transformation and simplification:

$$\begin{matrix}{F}_{2 L} y = {F}_{2 L} R ( {h}^{1} * {F}_{2 L}^{*} ( p ⊗ {e}_{0}^{2} ) ) + {F}_{2 L} ( {h}^{2} * {F}_{2 L}^{*} ( p ⊗ {e}_{1}^{2} ) ) + {F}_{2 L} n \\ = {F}_{2 L} {RF}_{2 L}^{*} {F}_{2 L} ( {h}^{1} * {F}_{2 L}^{*} ( p ⊗ {e}_{0}^{2} ) ) + \\ {F}_{ 2 L} ( {h}^{ 2} * {F}_{ 2 L}^{*} ( p ⊗ {e}_{ 1}^{ 2} ) ) + {F}_{ 2 L} n \\ = {F}_{2 L} {RF}_{2 L}^{*} diag ( p ⊗ {e}_{0}^{2} ) {F}_{2 L \times L} {h}^{1} + \\ diag ( p ⊗ {e}_{ 1}^{ 2} ) {F}_{ 2 L \times L} {h}^{ 2} + {F}_{ 2 L} n\end{matrix} \qquad ( 4.7 )$$

It is easy to prove that F_{2L}RF*_{2L} is a diagonal matrix. Therefore the training sequences related to different users are still kept orthogonal in the frequency domain according to (4.7) below. The last equation in (4.7) uses the result in (4.4).

We can analyse the alternative system performances on the perfect multi-access synchronization situation. The mean square error (MSE) of the conventional proposal can be deduced from (3.2).

$$\begin{matrix}MSE 1 = E \{ {‖ \hat{h} - [ \begin{matrix}{h}^{1} \\ {h}^{2}\end{matrix} ] ‖}^{2} \} \\ = E \{ {‖ \tilde{n} ‖}^{2} \} \\ = E \{ {\tilde{n}}^{*} \tilde{n} \} \\ = \frac{1}{2 L} E \{ {\sum }_{l = 0}^{2 L - 1} {{s}^{1} ( l )}^{*} {nn}^{*} {s}^{1} ( l ) \} \\ = \frac{1}{2 L} {\sum }_{l = 0}^{2 L - 1} E \{ {n}^{*} {s}^{1} ( l ) {{s}^{1} ( l )}^{*} n \} \\ = \frac{1}{2 L} {\sum }_{l = 0}^{2 L - 1} E \{ {n}^{*} n \} \\ = 2 L {σ}^{2}\end{matrix} \qquad ( 4.7 )$$

where σ² denotes the average noise power and E{n*n}=2Lσ². The MSE of the presently described embodiment is also deduced in (4.8), which is the same as (4.7).

$$\begin{matrix}\begin{matrix}\begin{matrix} MSE 2 = E \{ {‖ \hat{h} - [ \begin{matrix}{h}^{1} \\ {h}^{2}\end{matrix} ] ‖}^{2} \} \\ = E \{ {‖ \tilde{n} ‖}^{2} \} \\ = E \{ {\tilde{n}}^{*} \tilde{n} \} \\ = E \{ [ \begin{matrix}{\tilde{n}}_{1}^{*} & {\tilde{n}}_{2}^{*}\end{matrix} ] [ \begin{matrix}{\tilde{n}}_{1}^{*} \\ {\tilde{n}}_{2}\end{matrix} ] \} \\ = {\sum }_{i = 1}^{2} {\tilde{n}}_{i}^{*} {\tilde{n}}_{i} \\ = 2 L {σ}^{2}\end{matrix} \\ where\end{matrix} & ( 4.8 ) \\ \begin{matrix}E \{ {\tilde{n}}_{i}^{*} {\tilde{n}}_{i} \} = E \{ {n}^{*} {F}_{2 L}^{*} diag ( p ⊗ {e}_{i}^{2} ) {F}_{2 L , Φ ( i )} {F}_{2 L , Φ ( i )}^{*} {diag ( p ⊗ {e}_{i}^{2} )}^{*} {F}_{2 L} n \} \\ = {σ}^{2} tr \{ {F}_{2 L , Φ ( i )}^{*} {diag ( p ⊗ {e}_{i}^{2} )}^{*} {F}_{2 L} {F}_{2 L}^{*} diag ( p ⊗ {e}_{i}^{2} ) {F}_{2 L , Φ ( i )} \} \\ = {σ}^{2} tr \{ diag ( {1}_{L \times 1} ⊗ {e}_{i}^{2} ) {F}_{2 L , Φ ( i )} {F}_{2 L , Φ ( i )}^{*} \} \\ = {σ}^{2} tr \{ \frac{1}{2} {I}_{2 L \times 2 L} \} \\ = L {σ}^{2}\end{matrix} & ( 4.9 )\end{matrix}$$

Lemma 1

If p is a L×1 CAZAC sequence, then sequence u=p [symbol] eᵢ^{K} is a zero autocorrelation sequence where
eᵢ^{K}=[0_{1×i} 1 0_{1×(K-i-1)}]* (a.1)
and [symbol] denotes Kronecker product.

Proof Define N×N cyclic-shift matrix Γᵢ^{N} in (a.2)

$${Γ}_{i}^{N} = [ \begin{matrix}{0}_{i \times ( N - i )} & {I}_{i \times i} \\ {I}_{( N - i ) \times ( N - i )} & {0}_{( N - i ) \times i}\end{matrix} ] , i = 0 , … , N - 1 \qquad ( a .2 )$$

where I_{l,l} denotes l×l size identity matrix. It is noted that Γᵢ^{N} can be diagonalized by F_{N}, and its diagonal elements are
Λᵢ^{N}=F*_{N}Γᵢ^{N}F_{N}
λ_{i,l}^{N}=exp(j2πil/N),l=0, . . . , N−1 (a.3)

Using (a.2), the autocorrelation function cᵢ(u) is defined as
cᵢ(u)=u*Γᵢ^{KL}u=(peₗ^{K})*Γᵢ^{KL}(peₗ^{K}) (a.4)

If substitute mK+n for i, then

$$\begin{matrix}{c}_{i} ( u ) = ( {p}^{*} ⊗ {e}_{l}^{{K}^{*}} ) {Γ}_{mK + n}^{KL} ( p ⊗ {e}_{l}^{K} ) \\ = ( {p}_{n}^{*} ⊗ {e}_{l + m}^{K} ) ( p ⊗ {e}_{l}^{K} ) \\ = ( {p}_{n}^{*} p ) ⊗ ( {e}_{l + m}^{{K}^{*}} {e}_{l}^{K} ) \\ = \{ \begin{matrix}1 , & n , m = 0 \\ 0 , & \begin{matrix}n = 1 , … L - 1 and \\ m = 1 , … K - 1\end{matrix}\end{matrix}\end{matrix} \qquad ( a .5 )$$

Lemma 2

If u is a N×1 size zero autocorrelation sequence, then sequence v=F*_{N}u is a constant amplitude sequence.

Proof Define diagonal matrix V=diag(v) where v is a constant amplitude sequence which is equivalent to V*V=I. We can also define cyclic-shift Toeplitz matrix

$$U = {[ \begin{matrix}{u}^{*} ( 0 ) \\ {u}^{*} ( 1 ) \\ … \\ {u}^{*} ( N - 1 )\end{matrix} ]}^{*} \qquad ( b .1 )$$

It is easy to know that U*U=I using Lemma 1. And U can be diagonalized by V=F*_{N}UF_{N}, so that
V*V=F*_{N}U*F_{N}F*_{N}*UF_{N}=F*_{N}U*UF_{N}=I (b.2)
Numerical Simulations

The proposed uplink multi-user channel estimation scheme has been simulated with different channel conditions and the conventional CAZAC channel estimation method is used as a performance benchmark. The detailed environment specification is set as table 1:

TABLE 1
The simulation environment specifications

| | |
|---|---|
| Systems | 1. Conventional time domain CAZAC sequence for |
| | uplink multiuser channel estimation (Conv.) |
| | 2. Proposed frequency domain scattered CAZAC pilot |
| | for uplink multiuser channel estimation (Prop.) |
| Sampling Rate | 5 MHz |
| Block Size | 16 symbols |
| CP Size | 12 symbols |
| Carrier Frequency | 3 GHz |
| Modulation | QPSK |
| | Power Distribution Profile: |
| Channel Information | Equal energy distribution channel profile, |
| | channel memory length 8 Quasi-static Rayleigh fading |
| User count | 2 |
| | Conv. Totally 16 symbols, |
| | $User 1 : \{ {p}_{k} \} = \{ exp ( i \frac{π {k}^{2}}{16} ) \} , k = 0 , 1 , ⋯ , 15$ |
| | $User 2 : \{ {p}_{k} \} = \{ exp ( i \frac{π {k}^{2}}{16} ) \} , k = 8 , 9 , … , 15 , 0 , 1 , ⋯ , 7$ |
| CAZAC Training Sequence | Prop. Totally 16 symbols, |
| | $Define column vector p = \{ {p}_{k} \} = \{ exp ( i \frac{π {k}^{2}}{8} ) \} , k = 0 , 1 , ⋯ , 7$ |
| | $User 1 \text{:} {s}_{0} = {F}_{16}^{*} ( p ⊗ {e}_{0}^{2} )$ |
| | $User 2 \text{:} {s}_{1} = {F}_{16}^{*} ( p ⊗ {e}_{1}^{2} )$ |

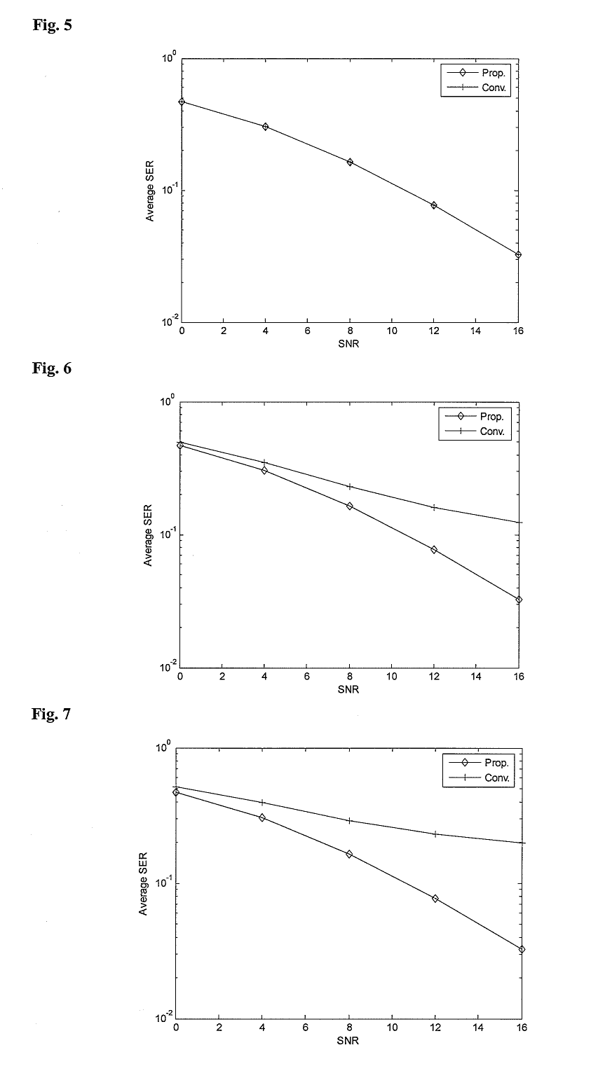

The symbol error rate (SER) versus signal to noise ratio (SNR) comparison results with perfect synchronization are presented in FIG. 5. The performances of the alternative systems are identical.

Besides the simulation with perfect multi-user synchronization in uplink, the SER performance comparison when there is a one-symbol and two-symbol misalignment of the multi-user signals in uplink has also been simulated. FIGS. 6 and 7 present the SER versus SNR comparison results with time misalign L_{Δ}, where L_{Δ} is one and two symbol duration length, respectively. It is noted that the performance of the conventional scheme degrades obviously and as the SNR increases, the SER error floor occurs due to interference from multi-user signal misalignment.

Misalignment among the users in uplink transmissions may induce severe interference on channel estimates over a pilot sequence such as a CAZAC sequence. According to embodiments of the present invention, a frequency domain scattering of the pilot structure is proposed where the pilot sequence is scattered over the whole allocated signalling bandwidth and where the training sequences assigned to the users are all orthogonal in frequency domain. System analysis and simulation results show that the proposed scheme significantly outperforms the conventional one.

Embodiments of the present invention may provide communications that are robust to misalignment among the users in uplink OFDMA/SC-FDMA/DFT-SOFDM systems. The feature of the conventional CAZAC scheme to keep the same constant amplitude correlation may still be preserved. Reduced complexity may be provided, since it is possible to reduce complex multiplications to NlogN (FFT) and complex division to N.

While this invention has been particularly shown and described with reference to various exemplary embodiments, it will be understood to those skilled in the art that various changes in form and detail may be made without departing from the scope of the invention as defined by the appendant claims.

1. A method, comprising: scattering a pilot sequence over a bandwidth allocated to a plurality of user equipment orthogonally in a frequency domain among the plurality of user equipment; and providing the plurality of user equipment with the scattered pilot sequence.

2. A method according to claim 1, wherein the pilot sequence is scattered over a whole bandwidth.

3. A method according to claim 1, wherein the pilot sequence is a constant amplitude zero auto-correlation (CAZAC) sequence.

4. A method according to claim 1, wherein the pilot sequence has a length of K*CML, where K is a number of uplink users and CML is a channel memory length.

5. A method according to claim 1, further comprising using the pilot sequence for channel estimation.

6. A method according to claim 1, further comprising providing the pilot sequence in a cyclic prefix-based single/multi-carrier communication system.

7. A method according to claim 1, further comprising providing the pilot sequence in an Evolved Universal Terrestrial Radio Access Network (E-UTRAN).

8. A method according to claim 1, further comprising providing the pilot sequence in a communication system based on at least one of an uplink orthogonal frequency division multiplexing (OFDMA), Single Carrier—Frequency Division Multiple Access (SC-FDMA), and Discrete Fourier Transform—Spread Orthogonal Frequency Division Multiplexing (DFT-SOFDM).

9. A method according to claim 1, wherein, for a pilot sequence of length KL where K is a number of uplink users and L is a channel memory length, the pilot sequence is given by the formula:
sᵢ=F*_{LK}(peᵢ^{K}),i=0, . . . , K−1
where p is a L×1 size CAZAC sequence, [symbol] denotes a Kronecker product, eᵢ^{K} is a column selective vector defined by
eᵢ^{K}=[0_{1×i} 1 0_{1×(K-i-1)}]*
and F_{LK} is an LK size FFT (Fast Fourier Transform) transforming matrix.

10. An apparatus, comprising: a processing unit adapted to scatter a pilot sequence over a bandwidth allocated to a plurality of user equipment orthogonally in a frequency domain among the plurality of user equipment and provide the plurality of user equipment with the scattered pilot sequence.

11. An apparatus according to claim 10, wherein the apparatus is a user equipment.

12. An apparatus according to claim 10, wherein the apparatus is a network element.

13. An apparatus according to claim 10, wherein the pilot sequence is scattered over a whole bandwidth.

14. An apparatus according to claim 10, wherein the pilot sequence is a constant amplitude zero auto-correlation (CAZAC) sequence.

15. An apparatus according to claim 10, wherein the pilot sequence has a length of K*CML, where K is a number of uplink users and CML is a channel memory length.

16. An apparatus according to claim 10, wherein the apparatus is adapted to use the pilot sequence for channel estimation.

17. An apparatus according to claim 10, wherein the pilot sequence is provided in a cyclic prefix-based single/multi-carrier communication system.

18. An apparatus according to claim 10, wherein the pilot sequence is provided in an Evolved Universal Terrestrial Radio Access Network (E-UTRAN).

19. An apparatus according to claim 10, wherein the pilot sequence is provided in a communication system based on at least one of an uplink orthogonal frequency division multiplexing (OFDMA), Single Carrier—Frequency Division Multiple Access (SC-FDMA), and Discrete Fourier Transform—Spread Orthogonal Frequency Division Multiplexing (DFT-SOFDM).

20. An apparatus according to claim 10, wherein, for a pilot sequence of length KL where K is a number of uplink users and L is a channel memory length, the pilot sequence is given by the formula:
sᵢ=F*_{LK}(peᵢ^{K}),i=0, . . . , K−1
where p is a L×1 size CAZAC sequence, [symbol] denotes a Kronecker product, eᵢ^{K} is a column selective vector defined by
eᵢ^{K}=[0_{1×i} 1 0_{1×(K-i-1)}]*
and F_{LK} is an LK size FFT (Fast Fourier Transform) transforming matrix.

21. An article of manufacture comprising a computer readable medium containing computer readable code, which when executed by a computer or processor causes said computer or processor to perform: scattering a pilot sequence over a bandwidth allocated to a plurality of user equipment orthogonally in a frequency domain among the plurality of user equipment; and providing the plurality of user equipment with the scattered pilot sequence.

22. An article of manufacture according to claim 21, wherein the pilot sequence is scattered over a whole bandwidth.

23. An article of manufacture according to claim 21, wherein the pilot sequence is a constant amplitude zero auto-correlation (CAZAC) sequence.

24. An article of manufacture according to claim 21, wherein the pilot sequence has a length of K*CML, where K is a number of uplink users and CML is a channel memory length.

25. A telecommunications network comprising a network element and a plurality of user equipment, the plurality of user equipment having a pilot sequence scattered orthogonally in a frequency domain over a bandwidth allocated to the plurality of user equipment and the network element being adapted to receive the pilot sequence and estimate channel information utilizing said pilot sequence.

26. A telecommunications network according to claim 25, wherein the pilot sequence is scattered over a whole bandwidth.

27. A telecommunications network according to claim 25, wherein the pilot sequence is a constant amplitude zero auto-correlation (CAZAC) sequence.

28. An apparatus comprising user equipment including a portion of a pilot sequence which has been scattered orthogonally in a frequency domain over a bandwidth allocated to a plurality of user equipment.

29. A system comprising a plurality of user equipment including a pilot sequence which is scattered orthogonally in a frequency domain over a bandwidth allocated to the plurality of user equipment.

30. An apparatus comprising a network element adapted to receive a pilot sequence scattered orthogonally in a frequency domain over a bandwidth allocated to a plurality of user equipment and estimate channel information utilizing said pilot sequence.

31. An apparatus comprising a network element adapted to allocate a bandwidth to a plurality of user equipment and provide the plurality of user equipment with a pilot sequence scattered over the bandwidth orthogonally in a frequency domain among the plurality of user equipment.

32. An apparatus, comprising: means for scattering a pilot sequence over a bandwidth allocated to a plurality of user equipment orthogonally in a frequency domain among the plurality of user equipment and means for provide the plurality of user equipment with the scattered pilot sequence.

33. A telecommunications network comprising a network element and a plurality of user equipment, the plurality of user equipment having a pilot sequence scattered orthogonally in a frequency domain over a bandwidth allocated to the plurality of user equipment and the network element comprising means for receiving the pilot sequence and means for estimating channel information utilizing said pilot sequence.

34. A network element comprising means for receiving a pilot sequence scattered orthogonally in a frequency domain over a bandwidth allocated to a plurality of user equipment and means for estimating channel information utilizing said pilot sequence.

35. A network element comprising means for allocating a bandwidth to a plurality of user equipment and means for providing the plurality of user equipment with a pilot sequence scattered over the bandwidth orthogonally in a frequency domain among the plurality of user equipment.
